(19) United States
(12) Patent Application Publication
(10) Pub. No.: US 2025/0118887 A1
(43) Pub. Date: Apr. 10, 2025

(54) ANTENNA ARRANGEMENT FOR EYEWEAR

(71) Applicant: GOOGLE LLC, Mountain View, CA (US)

(72) Inventors: Emeka Ugwu, Oakland, CA (US); Balamurugan Shanmugam, Fremont, CA (US); Sajeev Alakkatt Paleri, Santa Clara, CA (US); Charles R. Schabacker, San Jose, CA (US); Nan Xu, Sunnyvale, CA (US)

(21) Appl. No.: 18/484,010

(22) Filed: Oct. 10, 2023

(51) Int. Cl. H01Q 1/27; G02B 27/01; G02C 11/00; H01Q 1/48

(52) U.S. Cl. CPC H01Q 1/273; G02B 27/0176; G02C 11/10; H01Q 1/48; G02B 2027/0178

(57) ABSTRACT

An augmented reality (AR) or mixed reality (MR) eyewear display utilizes an antenna arrangement for eyewear that optimizes the performance of the antenna without sacrificing the functionality or modularity of the eyewear. In one implementation, the antenna arrangement includes a first conductor that functions as a ground for the antenna, a second conductor configured to help retain a lens, and an antenna feed configured to excite the second conductor, causing the second conductor to act as an antenna. The first and/or second conductor additionally acts as a lens retention feature by interfacing with a groove in a lens and the use of a locking clip that prevents the lens from becoming dislodged from the second conductor, thus enabling quick and easy installation or removal of the lens.

### BACKGROUND

In an augmented reality (AR) or mixed reality (MR) eyewear display, light from an image source is coupled into a light guide substrate, generally referred to as a waveguide, by an input optical coupling such as an in-coupling grating (i.e., an “incoupler”). The input optical coupling can be formed on one or more surfaces of the substrate or disposed within the substrate. Once the light has been coupled into the waveguide, the incoupled light is “guided” through the substrate, typically by multiple instances of total internal reflection, to then be directed out of the waveguide by an output optical coupling (i.e., an “outcoupler”), which can also take the form of an optical grating. The outcoupled light projected from the waveguide overlaps at an eye relief distance from the waveguide forming an exit pupil, within which a virtual image generated by the image source can be viewed by the user of the eyewear display. AR or XR displays often utilize antennas to communicate with other devices, such as a mobile phone, a router, a global positioning satellite, or other computing devices. However, communications interfaces in AR or XR displays that utilize antennas often suffer from one or more of the following: reduced separation of the antenna radiator from the ground plane, low radiation efficiency, and high coupling with other antennas inside the device enclosure due to the limited amount of space available to implement such interfaces.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating a rear perspective view of an augmented reality display device implementing an antenna arrangement for eyewear in accordance with some embodiments.

FIG. 2 is a diagram illustrating a first antenna arrangement for eyewear in accordance with some embodiments.

FIG. 3 is a diagram illustrating a second antenna arrangement for eyewear in accordance with some embodiments.

FIG. 4 is a diagram illustrating a third antenna arrangement for eyewear in accordance with some embodiments.

FIG. 5 is a diagram illustrating a fourth antenna arrangement for eyewear in accordance with some embodiments.

FIG. 6 is an exploded view illustrating a portion of an augmented reality display device implementing an antenna arrangement for eyewear in accordance with some embodiments.

### DETAILED DESCRIPTION

Designing and placing antennas in augmented reality (AR) eyewear presents a unique set of challenges due to their compact form factor and the need to balance performance, aesthetics, and user experience. AR eyewear are designed to overlay digital information onto the user's view of the real world, and their size and/or weight constraints limit the available space for antenna integration. As AR eyewear becomes more sophisticated, supporting various communication technologies like Wi-Fi, Bluetooth, and cellular connectivity, the complexity of antenna placement increases significantly. One of the main difficulties is achieving efficient wireless communication without compromising the AR eyewear's sleek and lightweight design. Antennas typically require a certain physical size to achieve optimal performance, but incorporating larger antennas can make the eyewear bulky and visually unappealing. The challenge lies in finding innovative ways to place and miniaturize the antennas without sacrificing signal quality and range. Moreover, AR eyewear is worn on the user's head, making their environment highly dynamic. The position and orientation of the eyewear can change frequently, affecting the antenna's radiation pattern and signal reception. Engineers must carefully analyze the impact of head movements on signal strength to ensure reliable communication in different scenarios.

Another concern is the potential for interference between different antennas within the AR eyewear. AR eyewear devices often support multiple communication technologies, each requiring its own antenna. Ensuring that these antennas do not interfere with each other is a complex task that involves electromagnetic simulation and careful antenna placement. Additionally, AR eyewear users expect seamless connectivity and high data transfer rates. Achieving this requires antennas capable of handling dense data traffic while maintaining power efficiency. Power consumption is a critical consideration for wearable devices, and the antenna's design must strike a balance between power efficiency and performance. Accordingly, placing antennas in AR or XR eyewear requires a delicate balance between technical constraints and user expectations. By carefully miniaturizing antennas, optimizing their radiation patterns, managing interference, and maintaining power efficiency, AR eyewear can be created that offers reliable and immersive experiences without compromising on aesthetics or comfort.

As noted above, AR wearable devices in eyewear form factors should be compact and lightweight while also maintaining a high level of wireless connectivity and the location of antennas in the eyewear should be selected carefully so as to maximize communication efficiency while minimizing undesirable interactions with the user wearing the device, which could introduce interference. The rims or frame of eyewear are a desirable location for placement of antennas; however, the rims generally have minimal volumes with a number of components competing for the space. Integration of prescription ophthalmic lenses is often desirable for AR wearable devices. It is also desirable to enable third parties, such as optometrists, to fulfill prescription ophthalmic lens orders or replace lenses as needed. One solution to this problem, as described herein, involves the implementation of a retention ring to ensure the robustness of the device. A retention ring is a minimal volume retention feature that also provides the requisite strength and ability to, e.g., insert or change the lens after other components of the device are manufactured. However, this addition has the potential to interfere with antenna performance, which could necessitate a relocation of the antenna systems. In some embodiments, the position of the antenna in the rim of eyewear is maintained while ensuring performance of both the antenna and lens retention function through the use of specific types of antenna arrangements.

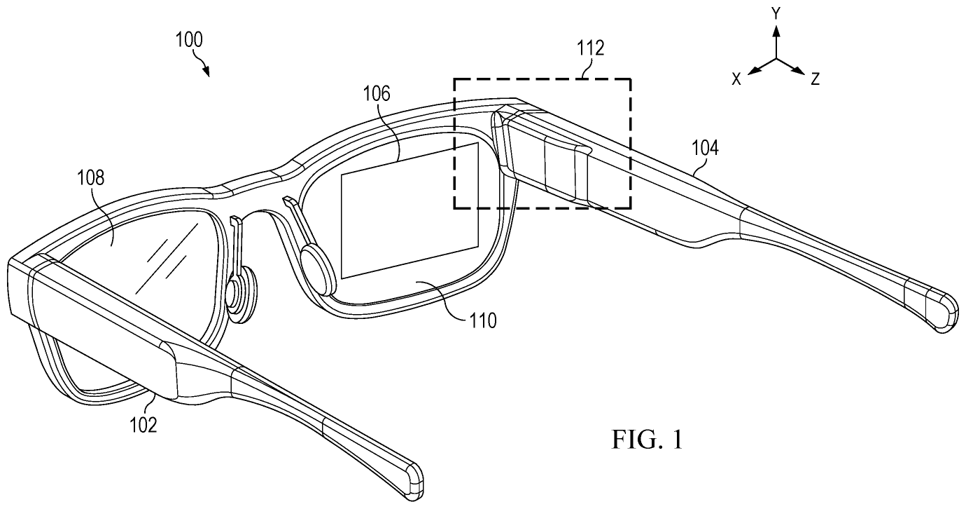

FIGS. 1-6 illustrate devices and techniques for implementing an antenna arrangement for eyewear. Some embodiments include integrated antenna and lens retention ring concepts that allow eyewear to be designed such that the lens retention ring performs the dual functions of lens retention and serving as antenna elements, while maintaining a stringent alignment of optical components, environmental sealing, and robustness under multiple mechanical and environmental test conditions. In some embodiments, an antenna arrangement for eyewear includes a first antenna element connected to a system radio (e.g., radio frequency or WiFi) via a transmission line, which may be implemented by any of various means such as flexible printed circuit boards, embedded metal plated onto plastic, or coaxial cables, among others, and a metal retention ring integrated directly into the display system assembly. The antenna shape and gaps or clearances between the first antenna element and the retention ring are in some embodiments controlled by means of various mechanical features such as spacers, springs, or other components to ensure optimal performance.

Using aspects of the present disclosure, various ranges of prescription ophthalmic lens components or other lenses, such as tinted non-prescription lenses, can be quickly and easily secured to or replaced in AR or XR eyewear, enabling the manufacturing process of the AR or XR eyewear to be decoupled from the manufacturing process for lens components. Accordingly, aspects of the present disclosure enable modular AR or XR eyewear that does not need to take a user's prescription into account at the time of manufacturing while still allowing lenses such as prescription lenses or tinted lenses to be readily installed or replaced in the eyewear by an optician or an end user.

FIG. 1 illustrates an AR eyewear display system 100 implementing an antenna arrangement for eyewear in accordance with some embodiments. The AR eyewear display system 100 includes a support structure 102 (e.g., a support frame) to mount to a head of a user and that includes an arm 104 that houses a laser projection system, micro-display (e.g., micro-light emitting diode (LED) display), or other light engine configured to project display light representative of images toward the eye of a user, such that the user perceives the projected display light as a sequence of images displayed in a field of view (FOV) area 106 at one or both of lens elements 108, 110 supported by the support structure 102. In some embodiments, the support structure 102 further includes various sensors, such as one or more front-facing cameras, rear-facing cameras, other light sensors, motion sensors, accelerometers, and the like. The support structure 102 further can include one or more antenna arrangements, such as radio frequency (RF) interfaces or other wireless interfaces, such as a Bluetooth™ interface, a WiFi interface, and the like.

The support structure 102 further can include one or more batteries or other portable power sources for supplying power to the electrical components of the AR eyewear display system 100. In some embodiments, some or all of these components of the AR eyewear display system 100 are fully or partially contained within an inner volume of support structure 102, such as within the arm 104 in region 112 of the support structure 102. In the illustrated implementation, the AR eyewear display system 100 utilizes a spectacles or eyeglasses form factor. However, the AR eyewear display system 100 is not limited to this form factor and thus may have a different shape and appearance from the eyeglasses frame depicted in FIG. 1.

One or both of the lens elements 108, 110 are used by the AR eyewear display system 100 to provide an AR display in which rendered graphical content can be superimposed over or otherwise provided in conjunction with a real-world view as perceived by the user through the lens elements 108, 110. For example, laser light or other display light is used to form a perceptible image or series of images that are projected onto the eye of the user via one or more optical elements, including a waveguide, formed at least partially in the corresponding lens element. One or both of the lens elements 108, 110 thus includes at least a portion of a waveguide that routes display light received by an incoupler (IC) (not shown in FIG. 1) of the waveguide to an outcoupler (OC) (not shown in FIG. 1) of the waveguide, which outputs the display light toward an eye of a user of the AR eyewear display system 100. Additionally, the waveguide employs an exit pupil expander (EPE) in the light path between the IC and OC, or in combination with the OC, in order to increase the dimensions of the display exit pupil. Moreover, each of the lens elements 108, 110 is sufficiently transparent to allow a user to see through the lens elements to provide a field of view of the user's real-world environment such that the image appears superimposed over at least a portion of the real-world environment.

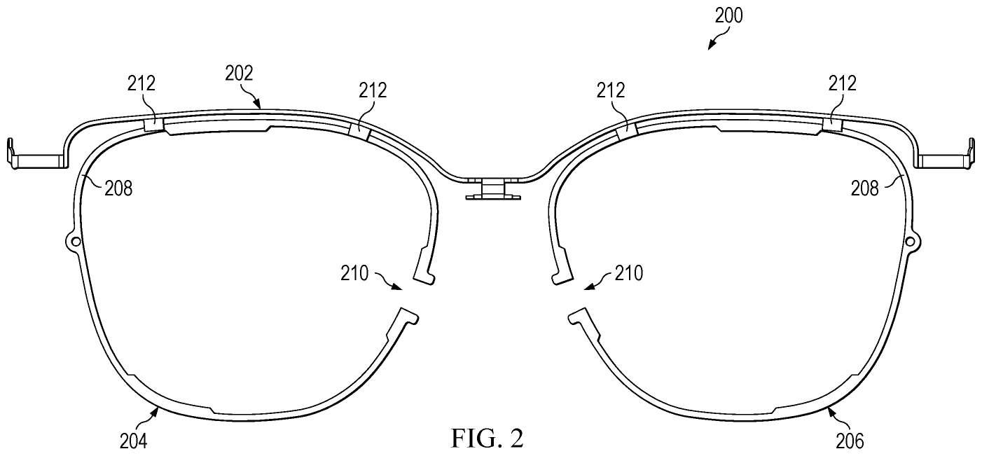

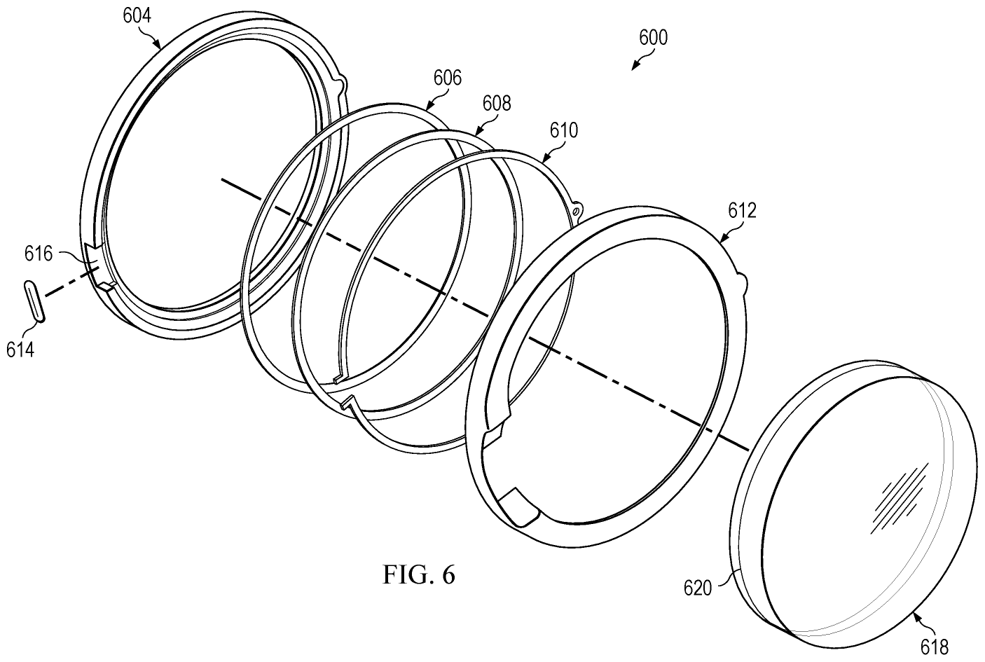

FIG. 2 is a diagram illustrating a first antenna arrangement 200 for eyewear in accordance with some embodiments, which may be incorporated into an AR eyewear display system such as eyewear display system 100 of FIG. 1. The first antenna arrangement 200 includes a first conductor 202 spanning at least a portion of an upper brow region of the eyewear, which in some embodiments functions as a ground for the first antenna arrangement 200 (e.g., for one or more antenna feeds). A second conductor 204 and a third conductor 206 extend along at least a portion of a perimeter of a lens element such as one of the lens elements 108, 110 of FIG. 1 and, in some embodiments, are configured to retain the lens element or a portion of the lens element (such as a prescription ophthalmic lens). In order to retain a lens using the second conductor 204 and the third conductor 206, as described further hereinbelow in the context of FIG. 6, a groove may be disposed on an external perimeter of the lens elements such that one or more of the conductors fits into the groove and, once secured in place, will be secured around the lens and confined within the groove, preventing the lens from moving relative to the retaining conductor(s). In some embodiments, the conductors are secured in place within the groove using a pin, locking clip, glue, or other securing mechanism.

In some embodiments, an antenna feed point 208 located proximal to a temple region or hinge area of the eyewear on one or both (e.g., for dual band antennas) of the second conductor 204 and the third conductor 206 directly excites the second conductor 204 or the third conductor 206, or both, thus utilizing the second conductor 204 or third conductor 206, or both, as antennas. By using dual band antennas, communication on two different frequency bands can be performed simultaneously or selectively. This allows a device to dynamically choose the most suitable frequency band for communication based on factors like distance, interference, and data capacity. One or more gaps 210 proximal to the nose bridge region of the eyewear create open loops in the second conductor 204 or third conductor 206, or both. One or more grounding paths 212 connect an upper portion of one or more of the second conductor 204 and the third conductor 206 to the first conductor 202. By using an antenna arrangement with a ground plane above the excited conductors, the antenna radiation pattern can be directed downward from a user's face, which improves coupling efficiency with a device such as a mobile phone that is typically stored in a pocket, on a hip mount, or held in a location relatively lower than a user's eyes when a user is sitting or standing.

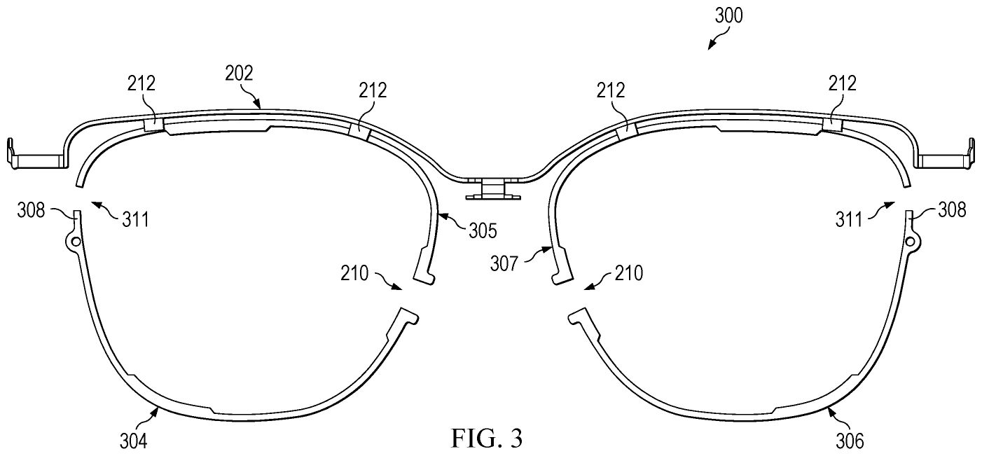

FIG. 3 is a diagram illustrating a second antenna arrangement 300 for eyewear in accordance with some embodiments, which may be incorporated into an AR eyewear display system such as eyewear display system 100 of FIG. 1. The second antenna arrangement 300 is similar to the first antenna arrangement 200, and so only distinguishing features of the second antenna arrangement 300 are discussed herein, while, as noted above, the use of the same reference symbols in different drawings (e.g., FIG. 2) indicates similar or identical items.

As shown in FIG. 3, proximal to a temple region or hinge area of the eyewear, the second antenna arrangement 300 includes a second gap 311 that is not present in the second conductor 204 or the third conductor 206 of FIG. 2, forming conductive lower portions 304, 306 and conductive upper portions 305, 307. In some embodiments, an antenna feed point 308 located proximal to a temple region or hinge area of the eyewear on one or both (e.g., for dual band antennas) of the conductive lower portion 304 and the conductive lower portion 306 excites the conductive lower portion 304 or the conductive lower portion 306, or both, thus utilizing the conductive lower portion 304 or the conductive lower portion 306, or both, as antennas with the upper portions 305, 307 and first conductor 202 functioning as the ground for the antenna feed. In some embodiments, a nonconductive material, such as plastic, is disposed in the second gap 311. By exciting one or both of the conductive lower portions 304, 306 in the second antenna arrangement 300, the antenna radiation pattern can be directed even more significantly downward than that of the first antenna arrangement 200, thus potentially further improving coupling efficiency with a device held lower than the user's eyes.

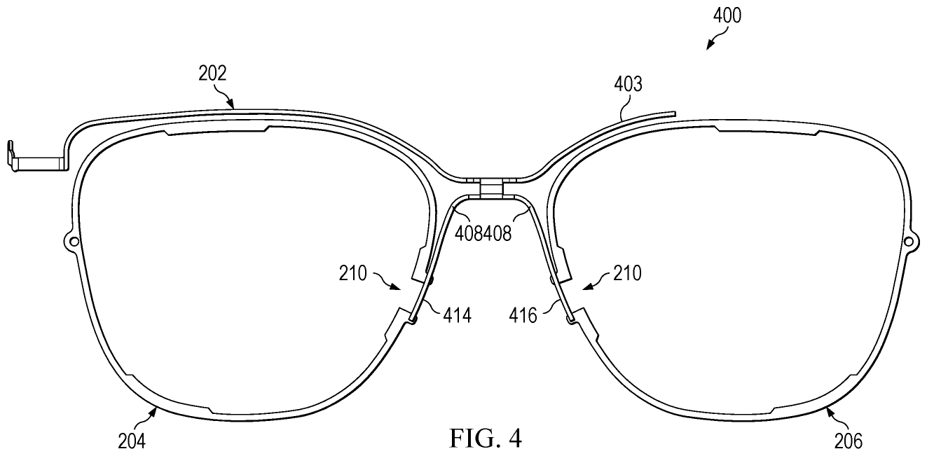

FIG. 4 is a diagram illustrating a third antenna arrangement 400 for eyewear in accordance with some embodiments, which may be incorporated into an AR eyewear display system such as eyewear display system 100 of FIG. 1. The third antenna arrangement 400 is similar to the first antenna arrangement 200, and so only distinguishing features of the third antenna arrangement 400 are discussed herein, while, as noted above, the use of the same reference symbols in different drawings (e.g., FIG. 2) indicates similar or identical items.

In some embodiments, an antenna feed point 408 located proximal to a nose bridge region of the eyewear on one or both (e.g., for dual band antennas) of a first nose bridge conductor 414 and a second nose bridge conductor 416 excites the first nose bridge conductor 414 or the second nose bridge conductor 416, or both, thus utilizing the first nose bridge conductor 414 or the second nose bridge conductor 416, or both, as antennas, with the first conductor 202 functioning as the ground for the antenna feed. The first nose bridge conductor 414 and the second nose bridge conductor 416 extend downward from the first conductor 202 and are located proximal to left and right sides of the nose bridge region of the eyewear. In some embodiments, one or both of the first nose bridge conductor 414 and the second nose bridge conductor 416 are parasitically coupled (e.g., using indirect excitation or capacitive coupling) to one of the second conductor 204 or the third conductor 206 (or both, respectively).

As shown in FIG. 4, the first conductor 202 includes a counterpoise region 403 located above the second nose bridge conductor 416 and extending from a central region of the eyewear spaced from and along an upper region of the third conductor 206. The counterpoise region 403 is a conductive structure that acts as a ground plane to improve the efficiency and radiation pattern of the third antenna arrangement 400 by providing a return path for the antenna's current. The counterpoise region 403 helps to ensure sufficient isolation between the first nose bridge conductor 414 and the second nose bridge conductor 416 when both are utilized as antennas without significantly increasing the footprint or spatial geometry of the third antenna arrangement 400.

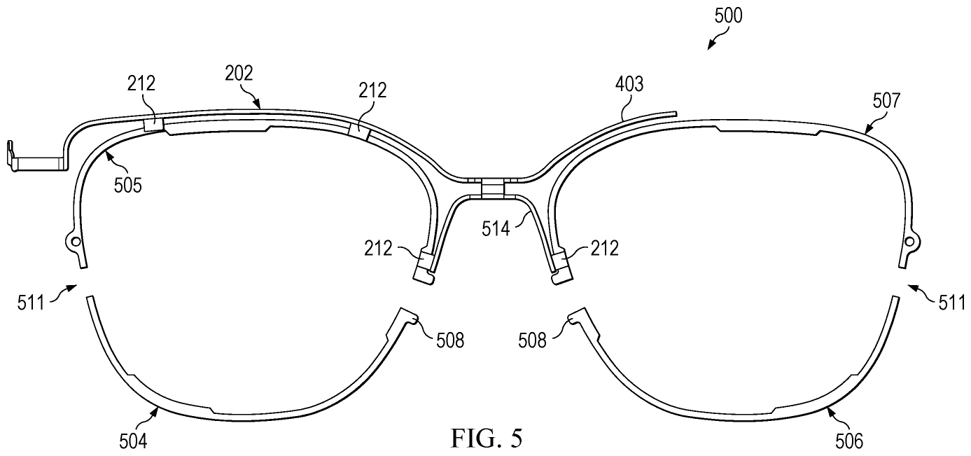

FIG. 5 is a diagram illustrating a fourth antenna arrangement 500 for eyewear in accordance with some embodiments, which may be incorporated into an AR eyewear display system such as eyewear display system 100 of FIG. 1. The fourth antenna arrangement 500 is similar to the first antenna arrangement 200, and so only distinguishing features of the third antenna arrangement 400 are discussed herein, while, as noted above, the use of the same reference symbols in different drawings (e.g., FIG. 2) indicates similar or identical items.

As shown in FIG. 5, proximal a temple region or hinge area of the eyewear, the fourth antenna arrangement 500 includes a second gap 511 that is similar to the second gap 311 of FIG. 3 but not present in the second conductor 204 of FIG. 2, forming conductive lower portions 504, 506 and conductive upper portions 505, 507. In some embodiments, a nonconductive material, such as plastic, is disposed in the second gap 511. Additional grounding paths 212 connect one or more of the conductive upper portions 505, 507 with a nose bridge conductor 514, which is in electrical communication with the first conductor 202.

In some embodiments, an antenna feed point 508 located proximal a nose bridge region of the eyewear on one or both (e.g., for dual band antennas) of conductive lower portions 504, 506 and/or one or both of conductive upper portions 505, 507 directly excites one or both of the conductive lower portions 504, 506 and/or one or both of the conductive upper portions 505, 507, thus utilizing one or both of the conductive lower portions 504, 506 and/or one or both of the conductive upper portions 505, 507 as antennas, with the first conductor 202 functioning as the ground for the antenna feed. As noted previously, by using an antenna arrangement with a ground plane above the excited conductors, the antenna radiation pattern can be directed downward from a user's face, which improves coupling efficiency with a device such as a mobile phone that is typically stored in a pocket, on a hip mount, or held in a location relatively lower than a user's eyes when a user is sitting or standing. By exciting one or both of the conductive lower portions 504, 506 in the fourth antenna arrangement 500, the antenna radiation pattern can be directed even more significantly downward, thus potentially further improving coupling efficiency with a device held lower than the user's eyes.

FIG. 6 is an exploded view illustrating a portion of an AR display device 600 implementing an antenna arrangement for eyewear in accordance with some embodiments, which may form a portion of an AR eyewear display system such as eyewear display system 100 of FIG. 1. The AR display device 600 includes a front frame (not shown), a waveguide carrier 604, adhesive 606, a foam seal 608, a retention ring 610, and a rear frame 612, which may also include a nosepiece or nose pad (not shown). In some embodiments, the retention ring 610 corresponds to one or more of the second conductor 204 and the third conductor 206 of FIG. 2 or 4, one or more sets of lower portions 304, 306 and upper portions 305, 307 of FIG. 3, or one or more sets of lower portions 504, 506 and upper portions 505, 507 of FIG. 5. Notably, the first conductor 202 of FIGS. 2-5 may be disposed in the front frame, the waveguide carrier 604, and/or the rear frame 612. A locking clip 614 insertable through a slot 616 in the waveguide carrier 604 enables quick and easy installation of a prescription ophthalmic lens 618 into the AR display device 600, e.g., after the AR display device 600 is manufactured.

By aligning a groove 620 formed on an external perimeter of the prescription ophthalmic lens 618 with the retention ring 610, inserting the aligned prescription ophthalmic lens 618 and retention ring 610 into the waveguide carrier 604, and inserting the locking clip 614 through the slot 616 such that the locking clip 614 secures the retention ring 610 to the ophthalmic lens 618, the prescription ophthalmic lens 618 can be secured to the waveguide carrier. The front frame and the rear frame 612 may be connected with snap features, screws, or any other suitable other joining mechanism. By enabling quick and easy installation (or removal) of the prescription ophthalmic lens 618 through use of the locking clip 614, manufacturing of the AR display device 600 can be simplified, as the front frame, waveguide carrier 604, adhesive 606, foam seal 608, retention ring 610, and rear frame 612 can be manufactured in advance with the ability to later add the prescription ophthalmic lens 618 or to swap out the prescription ophthalmic lens 618 for a different prescription, a tinted lens, or a nonprescription lens. In some embodiments, where no vision correction is required, either a nonprescription lens is used in place of the prescription ophthalmic lens 618 or the lens may be omitted.

In some embodiments, certain aspects of the techniques described above, such as generating driving signals for antenna feeds, receiving signals from one or more antennas, and generating AR or XR imagery may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An antenna arrangement for eyewear comprising:
a first conductor spanning at least a portion of an upper brow region of the eyewear;
a second conductor configured to retain a first lens;
a grounding path connecting the first conductor to the second conductor; and
a first antenna feed configured to excite the second conductor.

2. The antenna arrangement of claim 1, wherein the second conductor extends along at least a portion of a perimeter of the first lens.

3. The antenna arrangement of claim 2, wherein the second conductor includes a first gap.

4. The antenna arrangement of claim 3, wherein the first gap is located proximal to a nose bridge region of the eyewear.

5. The antenna arrangement of claim 4, wherein the first antenna feed is located proximal to a temple region of the eyewear.

6. The antenna arrangement of claim 3, wherein the second conductor includes a second gap proximal to a temple region of the eyewear, the first gap and the second gap forming an upper portion and a lower portion of the second conductor.

7. The antenna arrangement of claim 6, wherein the first antenna feed is configured to excite the lower portion of the second conductor.

8. The antenna arrangement of claim 6, wherein the first antenna feed is configured to excite the upper portion or the lower portion of the second conductor.

9. The antenna arrangement of claim 8, further comprising:
a third conductor configured to retain a second lens; and
a second antenna feed configured to excite the third conductor;
wherein the first conductor includes a counterpoise region located above the third conductor and extending from a central region of the eyewear.

10. The antenna arrangement of claim 6, wherein a nonconductive material is disposed in the second gap.

11. The antenna arrangement of claim 1, wherein the first conductor functions as a ground for the first antenna feed.

12. The antenna arrangement of claim 1, wherein the grounding path connects an upper portion of the second conductor to the first conductor.

13. The antenna arrangement of claim 1, further comprising:
a third conductor configured to retain a second lens;
a grounding path connecting the first conductor to the third conductor; and
a second antenna feed configured to excite the third conductor.

14. The antenna arrangement of claim 13, wherein the first conductor functions as a ground for the second antenna feed.

15. An antenna arrangement for eyewear comprising:
a first conductor partially spanning an upper brow region of the eyewear;
a second conductor extending downward from the first conductor proximal to a first side of a nose bridge region of the eyewear; and
a first antenna feed configured to excite the second conductor,
wherein the first conductor functions as a ground for the first antenna feed.

16. The antenna arrangement of claim 15, further comprising:
a third conductor configured to retain a first lens, wherein the second conductor is parasitically coupled to the third conductor.

17. The antenna arrangement of claim 16, wherein the third conductor extends along at least a portion of a perimeter of the first lens and includes a first gap located proximal to a nose bridge region of the eyewear.

18. The antenna arrangement of claim 16, further comprising:
a fourth conductor extending downward from the first conductor proximal to a second side of the nose bridge region of the eyewear; and
a second antenna feed configured to excite the fourth conductor,
wherein the first conductor functions as a ground for the second antenna feed.

19. The antenna arrangement of claim 18, further comprising:
a fifth conductor configured to retain a second lens, wherein the fourth conductor is parasitically coupled to the fifth conductor.

20. The antenna arrangement of claim 19, wherein the first conductor includes a counterpoise region located above the fourth conductor and extending from a central region of the eyewear.
